(19) United States
(12) Patent Application Publication
(10) Pub. No.: US 2025/0088138 A1
(43) Pub. Date: Mar. 13, 2025

(54) ROOF RIDGE JOINER FOR WIREWAYS OF ROOFING SYSTEMS

(71) Applicant: GAF Energy LLC, Parsippany, NJ (US)

(72) Inventor: Dan Hua, San Jose, CA (US)

(21) Appl. No.: 18/830,302

(22) Filed: Sep. 10, 2024

Related U.S. Application Data
(60) Provisional application No. 63/582,173, filed on Sep. 12, 2023.

(51) Int. Cl. H02S 20/25; E04D 1/30; H02S 40/36

(52) U.S. Cl. CPC H02S 20/25; E04D 1/30; H02S 40/36; E04D 2001/305; E04D 2001/308

(57) ABSTRACT

A system includes a steep sloped roof having a roof deck, a ridge, and a ridge cap installed on the ridge. A plurality of photovoltaic modules is installed on the roof deck and arranged in an array. The array includes a first side. A wireway is installed proximate to the first side of the array and a cover is installed on the wireway. The cover includes an upper end that overlays at least a portion of the ridge cap.

### CROSS-REFERENCE TO RELATED APPLICATIONS

This application is a Section 111(a) application relating to and claiming the benefit of commonly-owned, co-pending U.S. Provisional Patent Application Ser. No. 63/582,173, filed Sep. 12, 2023, entitled “ROOF RIDGE JOINER FOR WIREWAYS OF ROOFING SYSTEMS,” the contents of which are incorporated herein by reference in its entirety.

### FIELD OF THE INVENTION

The present invention relates to roofing systems and, more particularly, photovoltaic systems with wireways and associated roof ridge joiners.

### BACKGROUND

Photovoltaic systems are installed on building roofs to generate electricity.

### SUMMARY

In some embodiments, a system includes a steep sloped roof, wherein the roof includes a roof deck and a ridge; a ridge cap installed on the ridge; a plurality of photovoltaic modules installed on the roof deck, wherein the plurality of photovoltaic modules is arranged in an array, wherein the array includes a first side; a wireway installed proximate to the first side of the array; and a cover installed on the wireway, wherein the cover includes an upper end, and wherein the upper end overlays at least a portion of the ridge cap.

In some embodiments, the cover includes an elongated body and a tab extending from the body at the upper end, wherein the tab overlays the at least a portion of the ridge cap. In some embodiments, the body includes a top section and side sections extending from the top section wherein the tab includes an upper portion, and wherein the upper portion of the tab extends from the top section of the body. In some embodiments, the body includes a first portion and a second portion attached to the first portion, and wherein the second portion includes the tab. In some embodiments, the second portion is removably attached to the first portion. In some embodiments, the ridge cap includes a first side, and wherein the tab overlays the first side of the ridge cap. In some embodiments, the first side of the ridge cap is sloped.

In some embodiments, the cover is moveable in at least a first direction that extends along the first side of the ridge cap, and wherein the tab is configured to be positioned along the first side of the ridge cap. In some embodiments, the at least a first direction includes a first direction and a second direction opposite the first direction. In some embodiments, the tab is attached to the first side of the ridge cap.

In some embodiments, a system includes a steep sloped roof, wherein the roof includes a roof deck and a ridge; a ridge cap installed on the ridge; a plurality of photovoltaic modules installed on the roof deck, wherein the plurality of photovoltaic modules is arranged in an array, wherein the array includes a first side and a second side opposite the first side; a first wireway installed proximate to the first side of the array; a second wireway installed proximate to the second side of the array; a first cover installed on the first wireway; and a second cover installed on the second wireway, wherein each of the first cover and the second cover includes an upper end, wherein the upper end of the first cover overlays a first portion of the ridge cap, and wherein the upper end of the second cover overlays a second portion of the ridge cap.

In some embodiments, each of the first cover and the second cover includes an elongated body and a tab extending from the body at the upper end thereof, and wherein the tab of the first cover overlays the first portion of the ridge cap and the tab of the second cover overlays the second portion of the ridge cap. In some embodiments, the body of each of the first cover and the second cover includes a first portion and a second portion attached to the first portion of the body, and wherein the second portion of the body includes the tab. In some embodiments, the second portion of the body of each of the first cover and the second cover is removably attached to the first portion of the body. In some embodiments, the ridge cap includes a first side, wherein the tab of the first cover and the tab of the second cover overlay the first side of the ridge cap. In some embodiments, each of the first cover and the second cover is moveable in at least a first direction that extends along the first side of the ridge cap, and wherein each of the tabs of the first cover and the second cover is configured to be positioned along the first side of the ridge cap.

In some embodiments, a system includes a steep sloped roof, wherein the roof includes a roof deck and a ridge, wherein the roof deck includes a first sloped side and a second sloped side, wherein the ridge is between the first sloped side and the second sloped side; a ridge cap installed on the ridge, wherein the ridge cap includes a first side and a second side; a first plurality of photovoltaic modules installed on the first sloped side of the roof deck, wherein the first plurality of photovoltaic modules is arranged in a first array, wherein the first array includes a first side and second side opposite the first side of the first array; a second plurality of photovoltaic modules installed on the second sloped side of the roof deck, wherein the second plurality of photovoltaic modules is arranged in a second array, wherein the second array includes a first side and a second side opposite the first side of the second array; a first wireway installed proximate to the first side of the first array; a first cover installed on the first wireway; a second wireway installed proximate to the second side of the first array; a second cover installed on the second wireway, a third wireway installed proximate to the first side of the second array; a third cover installed on the third wireway; and a fourth wireway installed proximate to the second side of the second array; and a fourth cover installed on the fourth wireway, wherein each of the first cover, the second cover, the third cover and the fourth cover includes an elongated body having an upper end, and a tab extending from the body at the upper end, wherein the tab of the first cover overlays a first portion of the first side of the ridge cap, wherein the tab of the second cover overlays a second portion of the first side of the ridge cap, wherein the tab of the third cover overlays a first portion of the second side of the ridge cap, and wherein the tab of the second cover overlays a second portion of the second side of the ridge cap.

In some embodiments, each of the first cover and the second cover is moveable in at least a first direction that extends along the first side of the ridge cap, wherein each of the tabs of the first cover and the second cover is configured to be positioned along the first side of the ridge cap, wherein each of the third cover and the fourth cover is moveable in at least a second direction that extends along the second side of the ridge cap, and wherein each of the tabs of the third cover and the fourth cover is configured to be positioned along the second side of the ridge cap. In some embodiments, the first cover and the second cover are symmetric with the third cover and the fourth cover. In some embodiments, the first cover and the second cover are asymmetric with the third cover and the fourth cover.

### BRIEF DESCRIPTION OF THE DRAWINGS

FIG. 1 is top perspective view of some embodiments of a roofing system with a photovoltaic system;

FIG. 2 is a top plan view of some embodiments of a photovoltaic module employed by the photovoltaic system of FIG. 1;

FIG. 3 is a top perspective view of some embodiments of a wire cover employed by the roofing system of FIG. 1;

FIG. 4 is top perspective view of some embodiments of a roofing system;

FIG. 5 is a top plan view of some embodiments of a roofing module employed by the roofing system of FIG. 4;

FIG. 6 is a top perspective view of some embodiments of a ridge roof joiner employed by the wire cover of FIG. 3;

FIG. 7 is an exploded view of some embodiments of the ridge roof joiner of FIG. 6 with a wire cover and a ridge cap of a roof;

FIG. 8 is a top plan view of some embodiments of two of the ridge roof joiners, the wire cover and the ridge cap of FIG. 7; and

FIG. 9 is a perspective view of a roofing system employing a plurality of the ridge roof joiners of FIG. 6.

### DETAILED DESCRIPTION

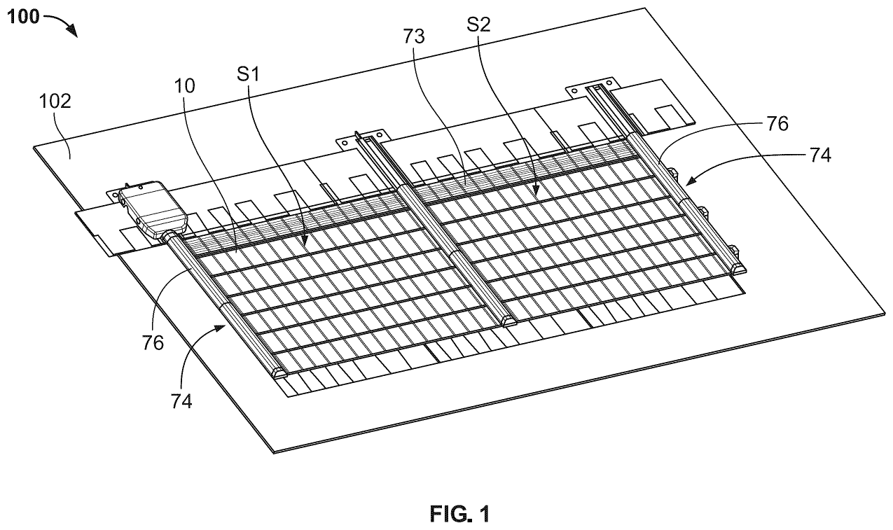

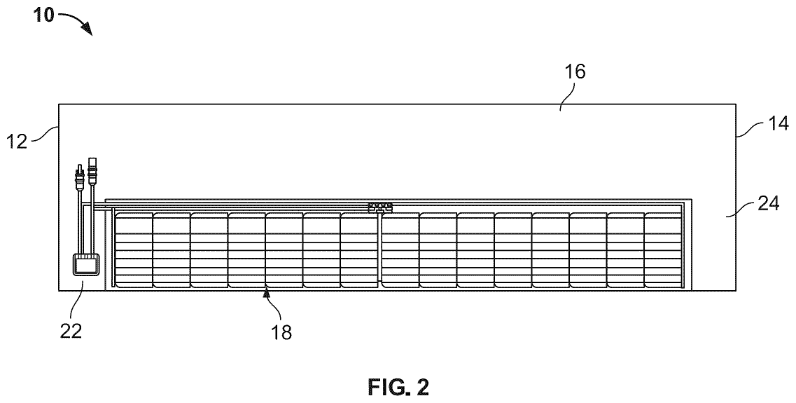

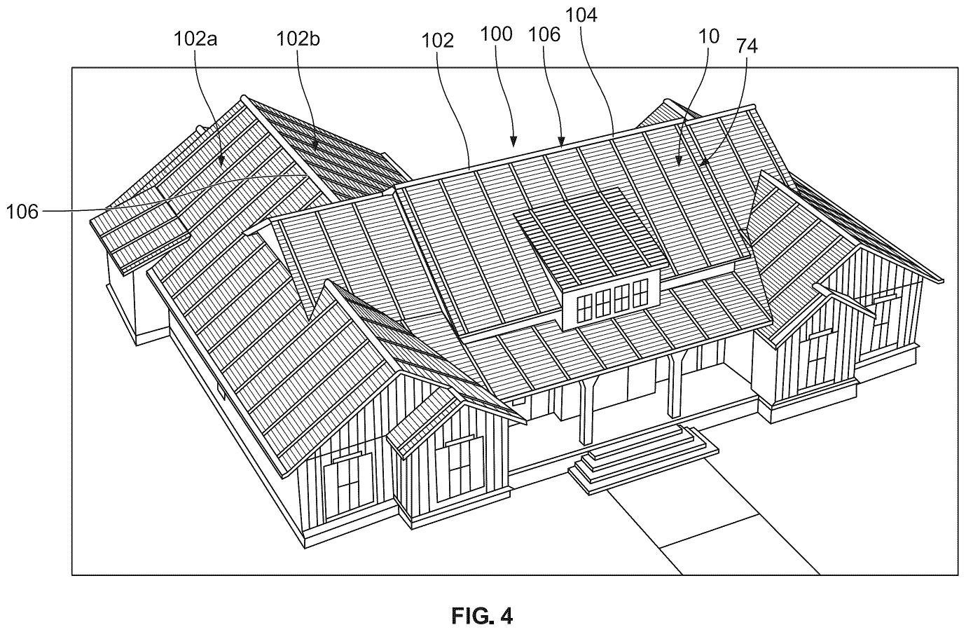

Referring to FIGS. 1 and 2, in some embodiments, a roofing system 100 includes a plurality of roofing modules 10 installed on a roof deck 102 of a roof. In some embodiments, the roof includes a ridge 104 (see FIG. 4). In some embodiments, the roofing modules 10 are photovoltaic modules 10. In some embodiments, each of the photovoltaic modules 10 includes at least one solar cell 20. In some embodiments, each of the photovoltaic modules 10 includes a plurality of solar cells 20. In some embodiments, each of the photovoltaic modules 10 includes a structure, composition, components, and/or function similar to those of one or more embodiments of the photovoltaic modules disclosed in PCT International Patent Publication No. WO 2022/051593, Application No. PCT/US2021/049017, published Mar. 10, 2022, titled “Building Integrated Photovoltaic System,” owned by GAF Energy LLC; U.S. Pat. No. 11,251,744 to Bunea et al., issued Feb. 15, 2022, titled “Photovoltaic Shingles and Methods of Installing Same, owned by GAF Energy LLC;” and U.S. Pat. No. 11,870,227, issued Jan. 9, 2024, entitled “Building Integrated Photovoltaic System,” owned by GAF Energy LLC, the disclosures of each of which are incorporated by reference herein in their entireties.

In some embodiments, the plurality of the photovoltaic modules 10 is arranged in an array on the roof deck 102. In some embodiments, the array of the photovoltaic modules 10 includes subarrays S1, S2. In certain embodiments, the array includes more than the two subarrays S1, S2. In some embodiments, the array includes a single array S1. In some embodiments, each of the subarrays S1, S2 include a plurality of rows of the photovoltaic modules 10.

In some embodiments, the roof deck 102 is a steep slope roof deck. In some embodiments, the roof deck 102 is a sloped roof deck. In some embodiments, the roof deck 102 is a flat roof deck. As used herein, a “steep slope” roof or roof deck is a roof or roof deck having a pitch of Y/X, where Y and X are in a ratio of 4:12 to 20:12, where Y corresponds to the “rise” of the roof or roof deck, and where X corresponds to the “run” of the roof or roof deck. As used herein, a “sloped” roof or roof deck is a roof or roof deck that is not flat, but has a pitch that is less than the pitch of a steep slope roof or roof deck. As used herein, a “flat” roof or roof deck is a roof or roof deck that is substantially flat.

In some embodiments, the roof is a gable roof. In some embodiments, the roof is a gambrel roof. In some embodiments, the roof is a hip roof. In some embodiments, the roof is a hip and valley roof. In some embodiments, the roof is a bonnet roof. In some embodiments, the roof is a Dutch gable roof. In some embodiments, the roof is a mansard roof. In some embodiments, the roof is a jerkinhead roof.

In some embodiments, the reveal portion 18 of one of the photovoltaic modules 10 in the subarray S1 overlays a head lap portion 16 of an adjacent another one of the photovoltaic modules 10 of the subarray S1. In some embodiments, at least a portion of a first side lap 22 of the one of the photovoltaic modules 10 overlays at least a portion of the first side lap 22 of the another one of the photovoltaic modules 10. In some embodiments, at least a portion of a second side lap 24 of the one of the photovoltaic modules 10 overlays at least a portion of the second side lap 24 of the another one of the photovoltaic modules 10.

In some embodiments, the first side lap 22 of one of the photovoltaic modules 10 in the subarray S2 overlays the second side lap 24 of an adjacent another one of the photovoltaic modules 10 in the subarray S1 in the same one of the rows In some embodiments, a jumper module 73 overlays an uppermost one of the photovoltaic modules 10 in a column of the subarray S1. In some embodiments, the active portion of the jumper module 73 overlays the head lap portion 16 of the photovoltaic module 10.

In some embodiments, the photovoltaic modules 10 are configured to be installed on a roof deck 102 with one or more fasteners. In some embodiments, the fasteners comprise one or more of nails, screws, staples, rivets, and/or combinations thereof.

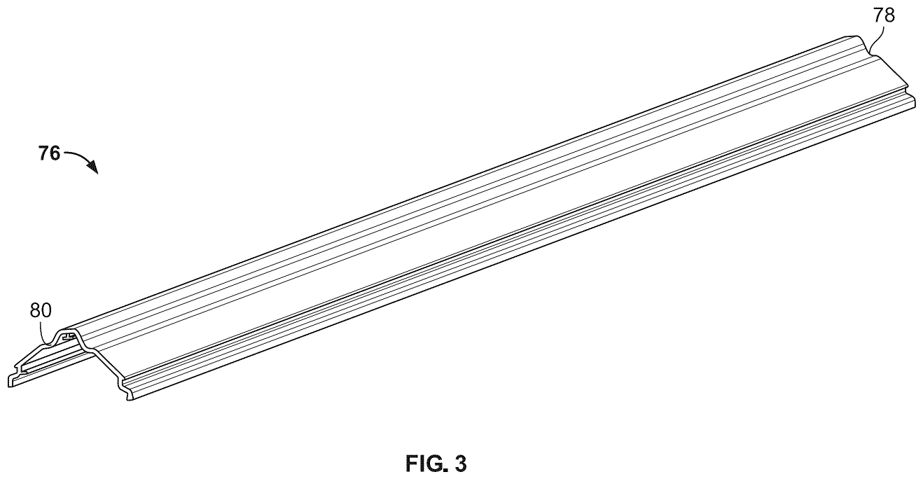

Referring to FIGS. 1 through 3, in some embodiments, the system 70 includes at least one wireway 74 installed proximate to first ends 12 of the photovoltaic modules 10. In some embodiments, the at least one wireway 74 is installed proximate to a second end 14 of the photovoltaic modules 10. In some embodiments, the at least one wireway 74 is installed intermediate the first end 12 of one of the photovoltaic modules 10 and a second end 14 of another one of the photovoltaic modules 10. In some embodiments, the at least one wireway 74 includes a wire cover 76. In some embodiments, the wire cover 76 includes a first end 78 and a second end 80 opposite the first end 78. In some embodiments, the wire cover 76 is removably attached to the at least one wireway 74. In some embodiments, the at least one wireway 74 includes a plurality of the wireways 74. In some embodiments, one of the wire covers 76 of one of the plurality of wireways 74 overlaps another of the wire covers 76 of another of the plurality of wireways 74. In some embodiments, the at least one wireway 74 includes a height of 1 mm to 20 mm. In some embodiments, the at least one wireway 74 includes a single wireway installed proximate to the first end of each of the photovoltaic modules 10. In some embodiments, the at least one wireway 74 does not include any electrical components or electrical wires or cables therein. In some embodiments, the at least one wireway 74 and the wire covers 76 include a structure, composition and/or function of similar to those of more or one of the embodiments of the wireways and wire covers disclosed in PCT International Patent Publication No. WO 2022/051593, Application No. PCT/US2021/049017, published Mar. 10, 2022, titled “Building Integrated Photovoltaic System,” owned by GAF Energy LLC; U.S. Pat. No. 11,251,744 to Bunea et al., issued Feb. 15, 2022, titled “Photovoltaic Shingles and Methods of Installing Same, owned by GAF Energy LLC;” U.S. Pat. No. 11,870,227, issued Jan. 9, 2024, titled “Building Integrated Photovoltaic System,” owned by GAF Energy LLC; and/or U.S. Pat. No. 12,013,153 to Clemente et al., issued Jun. 18, 2024, titled “Building Integrated Photovoltaic System,” and owned by GAF Energy LLC, the disclosures of each of which are incorporated by reference herein in their entireties. In some embodiments, the at least one wireway 74 and the wire covers 76 include a structure, composition and/or function of similar to those of more or one of the embodiments of the wireways and wire covers disclosed in U.S. Pat. No. 12,009,782 to West et al., issued Jun. 11, 2024, titled “Photovoltaic Systems with Wireways,” and owned by GAF Energy LLC, the disclosure of which is incorporated by reference herein in its entirety.

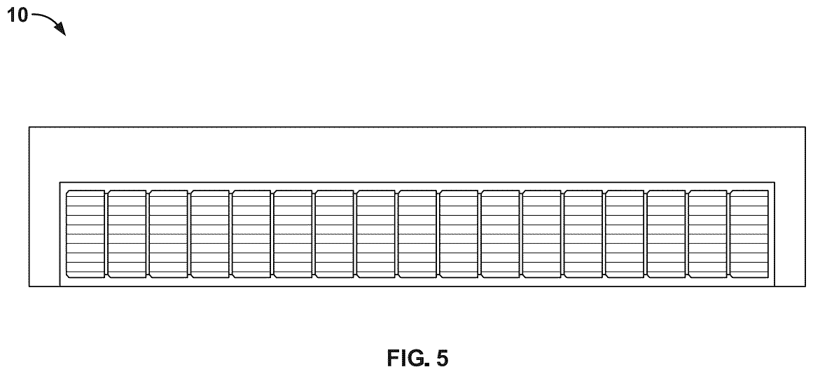

Referring to FIGS. 4 and 5, in some embodiments, the roofing modules 10 are non-photovoltaic roofing modules 10. In some embodiments, the non-photovoltaic module 10 is a cuttable roofing module. In some embodiments, the roofing module 10 includes a cap layer and a core layer. In some embodiments, the roofing module 10 is textured. In some embodiments, the roofing module 10 includes a printed pattern. In some embodiments, the printed pattern includes a depiction of solar cells. In some embodiments, the roofing modules 10 are roofing shingles 10. In some embodiments, the roofing module 10 includes a structure, composition and/or function of similar to those of more or one of the embodiments of the roofing modules disclosed in in U.S. application Ser. No. 17/831,307, filed Jun. 2, 2022, titled “Roofing Module System,” and published under U.S. Patent Application Publication No. 2022-0393637 on Dec. 8, 2022; and/or U.S. application Ser. No. 18/169,718, filed Feb. 15, 2023, titled “Roofing Module System,” and published under U.S. Patent Application Publication No. 2023-0203815 on Jun. 29, 2023; and/or U.S. application Ser. No. 18/352,894, filed Jul. 14, 2023, titled “Solar Roofing System with Fiber Composite Roofing Shingles,” and published under U.S. Patent Application Publication No. 2024-0018781 on Jan. 18, 2024, the disclosures of each of which are incorporated by reference herein in their entireties.

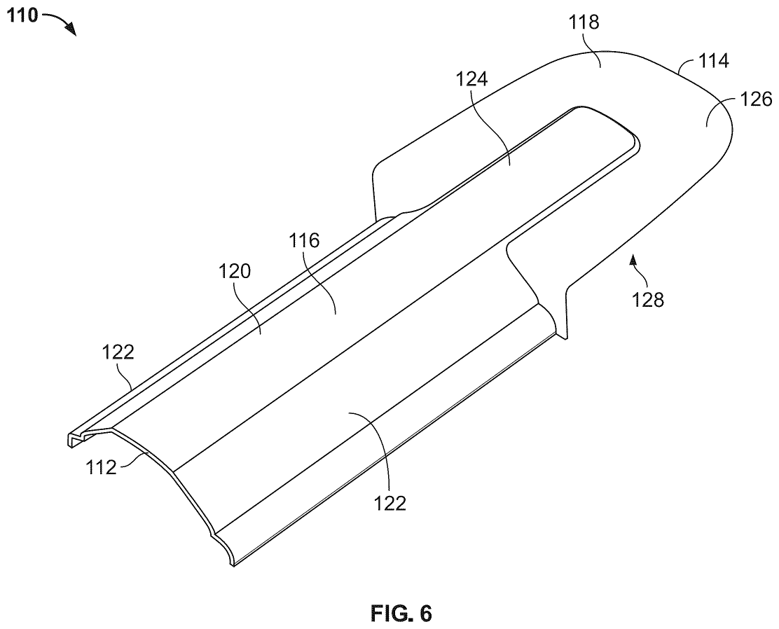

Referring to FIG. 6, in some embodiments, a roof ridge joiner 110 (“joiner 110”) includes a first end 112, a second end 114 opposite the first end 112, and an elongated body 116 extending from the first end 112 to a location intermediate the first end 112 and the second end 114. In some embodiments, a tab 118 extends from the body 116 at the second end 114. In some embodiments, the body 116 includes a top section 120 and side sections 122 extending from the top section 120. In some embodiments, each of the side sections 122 extend obliquely from the top section 120. In some embodiments, the body 116 includes a size, shape, cross-section and/or structure similar to those of the wire cover 76. In some embodiments, the tab 118 includes a top section 124 and an upper, flanged portion 126 extending from the top section 124. In some embodiments, the tab 118 is elevated relative to a lower portion of the body 116 and, in turn, a space 128 is located therebetween. In some embodiments, the tab 118 at the second end 114 includes a rounded-shaped end, a circular-shaped end, a square-shaped end, a curvilinear-shaped end, a rectangular-shaped end, a triangular-shaped end, a pointed end, or a polygonal-shaped end.

In some embodiments, the joiner 110 has a height of 1 mm to 20 mm. In some embodiments, the joiner 110 has a height of 1 mm to 15 mm. In some embodiments, the joiner 110 has a height of 1 mm to 10 mm. In some embodiments, the joiner 110 has a height of 1 mm to 5 mm. In some embodiments, the joiner 110 has a height of 5 mm to 20 mm. In some embodiments, the joiner 110 has a height of 5 mm to 15 mm. In some embodiments, the joiner 110 has a height of 5 mm to 10 mm. In some embodiments, the joiner 110 has a height of 10 mm to 20 mm. In some embodiments, the joiner 110 has a height of 10 mm to 15 mm. In some embodiments, the joiner 110 has a height of 15 mm to 20 mm.

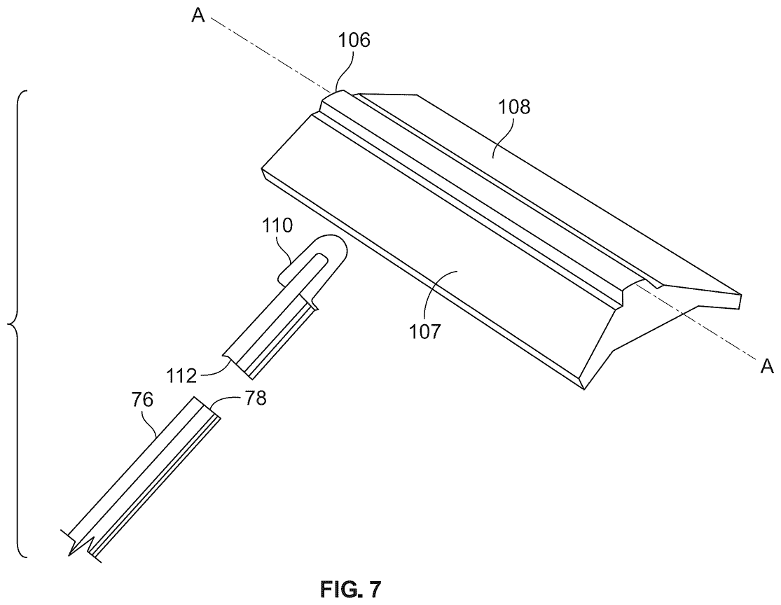

Referring to FIG. 7, in some embodiments, the joiner 110 is attached to the wire cover 76. In some embodiments, the joiner 110 is removably attached to the wire cover 76. In some embodiments, the first end 112 of the joiner 110 is attached to the first end 78 of the wire cover 76. In some embodiments, the joiner 110 is attached to the wire cover 76 by snap tabs thereon. In some embodiments, the respective snap tabs are integral with the joiner 110 and the wire cover 76. In some embodiments, the joiner 110 is attached to the wire cover 76 by fasteners, such as screws, clips, and hooks. In some embodiments, the joiner 110 is attached to the wire cover 76 by an adhesive. In some embodiments, the joiner 110 is attached to the wire cover 76 by features and structures as disclosed in PCT International Patent Publication No. WO 2022/051593, Application No. PCT/US2021/049017, published Mar. 10, 2022, titled “Building Integrated Photovoltaic System,” owned by GAF Energy LLC; U.S. Pat. No. 11,251,744 to Bunea et al., issued Feb. 15, 2022, titled “Photovoltaic Shingles and Methods of Installing Same, owned by GAF Energy LLC;” and U.S. Pat. No. 11,870,227, issued Jan. 9, 2024, entitled “Building Integrated Photovoltaic System,” owned by GAF Energy LLC; and/or U.S. Pat. No. 12,013,153 to Clemente et al., issued Jun. 18, 2024, entitled “Building Integrated Photovoltaic System,” owned by GAF Energy LLC, the contents of each of which are incorporated by reference herein in their entirety. In some embodiments, the joiner 110 is integral with the wire cover 76 and is the first, upper end thereof. In some embodiments, the joiner 110 and the wire cover 76 are a single component.

In some embodiments, the joiner 110 is plastic. In some embodiments, the joiner 110 is composed of a polymer. In some embodiments, the joiner 110 is composed of metal.

In some embodiments, the ridge 104 includes a ridge cap 106. In some embodiments, the ridge cap 106 is installed on the ridge 104. In some embodiments, the ridge cap 106 in composed of a polymer. In some embodiments, the ridge cap 106 in composed of a metal. In some embodiments, the ridge cap 106 in composed of wood. In some embodiments, the ridge cap 106 includes asphalt. In some embodiments, the ridge cap 106 includes asphalt roof shingles. In some embodiments, the ridge cap 106 in composed of asphalt. In some embodiments, the ridge cap 106 includes a ridge cap cover. In some embodiments, the ridge cap 106 includes a first side 107 and a second side 108. In some embodiments, the first side 107 is sloped. In some embodiments, the second side 108 is sloped. In some embodiments, each of the first side 107 and the second side 108 is sloped. In some embodiments, the ridge cap 106 is symmetrical. In some embodiments, the ridge cap 106 is asymmetrical. In some embodiments, the ridge cap 106 has a substantially triangular-shaped cross section. In some embodiments, the ridge cap 106 has a triangular-shaped cross section. In some embodiments, the ridge cap 106 has a semi-elliptical-shaped cross section.

In some embodiments, the ridge cap 106 has a square-shaped cross section. In some embodiments, the ridge cap 106 has a rectangular-shaped cross section. In some embodiments, the ridge cap 106 has a semi-circular-shaped cross section. In some embodiments, the ridge cap 106 has a polygonal cross section.

In some embodiments, the joiner 110 overlays the ridge cap 106. In some embodiments, the tab 118 overlays the first side 107 of the ridge cap 106. In some embodiments, the tab 118 overlays the second side 108 of the ridge cap 106. In some embodiments, the tab 118 overlays at least a portion of the ridge cap 106. In some embodiments, the space 128 of the joiner 110 is sized and shaped to receive the first side 107 or the second side 108. In some embodiments, the tab 118 is in contact with the at least a portion of the ridge cap 106. In some embodiments, the tab 118 is attached to the ridge cap 106. In some embodiments, the tab 118 is removably attached to the ridge cap 106. In some embodiments, the tab 118 is attached to the ridge cap 106 by screws, nails, staples, rivets, or an adhesive. In some embodiments, the joiner 110 is perpendicular to a longitudinal axis A-A of the ridge cap 106. In some embodiments, the joiner 110 is substantially perpendicular to a longitudinal axis A-A of the ridge cap 106.

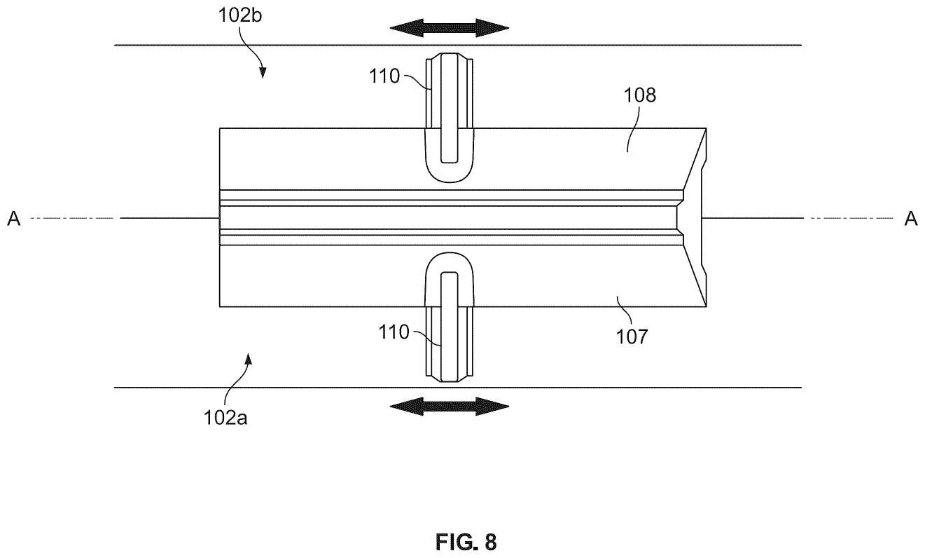

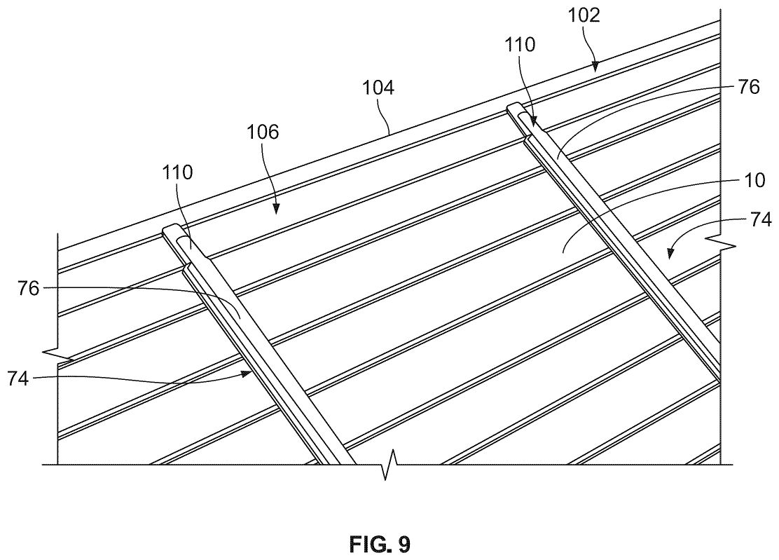

Referring to FIGS. 8 and 9, in some embodiments, the wire cover 76 and, in turn, the joiner 110, are moveable in at least a first direction along the longitudinal axis A-A of the ridge cap 106. In some embodiments, the wire cover 76 and the joiner 110 are moveable in at least the first direction along the longitudinal axis A-A of the ridge cap 106 that extends along the first side 107 of the ridge cap 106. In some embodiments, the wire cover 76 and the joiner 110 are moveable in at least the first direction along the longitudinal axis A-A of the ridge cap 106 that extends along the second side 108 of the ridge cap 106. In some embodiments, the at least a first direction includes a second direction opposite the first direction. In some embodiments, the position of the joiner 110 along the first side 107 or the second side 108 of the ridge cap 106 is adjustable. In some embodiments, the position of the joiner 110 along the first side 107 or the second side 108 of the ridge cap 106 is adjustable in either the first direction or the second direction.

In some embodiments, the position of the wire cover 76 and the joiner 110 along the first side 107 or the second side 108 of the ridge cap 106 is adjustable in either the first direction or the second direction by 0.1 inch to 10 inches. In some embodiments, the position of the wire cover 76 and the joiner 110 is adjustable in either the first direction or the second direction by 0.1 inch to 5 inches. In some embodiments, the position of the wire cover 76 and the joiner 110 is adjustable in either the first direction or the second direction by 0.1 inch to 1 inch. In some embodiments, the position of the wire cover 76 and the joiner 110 is adjustable in either the first direction or the second direction by 0.1 inch to.5 inch. In some embodiments, the position of the wire cover 76 and the joiner 110 is adjustable in either the first direction or the second direction by 0.5 inch to 10 inches. In some embodiments, the position of the wire cover 76 and the joiner 110 is adjustable in either the first direction or the second direction by 0.5 inch to 5 inches. In some embodiments, the position of the wire cover 76 and the joiner 110 is adjustable in either the first direction or the second direction by 0.5 inch to 1 inch. In some embodiments, the position of the wire cover 76 and the joiner 110 is adjustable in either the first direction or the second direction by 1 inch to 10 inches. In some embodiments, the position of the wire cover 76 and the joiner 110 is adjustable in either the first direction or the second direction by 1 inch to 5 inches.

In some embodiments, the roofing system 100 includes a plurality of wire covers 76 and a plurality of joiners 110, each of which is attached to or integral with a corresponding one of the plurality of wire covers 76. In some embodiments, a first plurality of the wire covers 76 and the corresponding plurality of the joiners 110 are located on a first portion 102a of the roof deck 102. In some embodiments, each of the first plurality of the wire covers 76 are spaced apart from one another. In some embodiments, each of the first plurality of the wire covers 76 are spaced apart from one another in a direction along the longitudinal axis A-A of the ridge cap 106. In some embodiments, the first plurality of the wire covers 76 and the corresponding plurality of the joiners 110 are located on a second portion 102b of the roof deck 102. In some embodiments, each of the first plurality of the wire covers 76 are spaced apart from one another.

In some embodiments, the plurality of joiners 110 overlay the first side of the ridge cap 106. In some embodiments, the plurality of joiners 110 overlay the second side 108 of the ridge cap 106. In some embodiments, a first plurality of the joiners 110 overlay the first side 107 of the ridge cap 106. In some embodiments, a second plurality of joiners 110 overlay the second side 108 of the ridge cap 106.

In some embodiments, the roofing system 100 includes an array of the roofing modules 10 on a first portion 102a of the roof deck 102. In some embodiments, the roofing system 100 includes an array of the roofing modules 10 on the first portion 102a of the roof deck 102 and on the same side as the first side 107 of the ridge cap 106. In some embodiments, the roofing system 100 includes another array of the roofing modules 10 on a second portion 102b of the roof deck 102. In some embodiments, the roofing system 100 includes an array of the roofing modules 10 on the second portion 102b of the roof deck 102 and on the same side as the second side 108 of the ridge cap 106. In some embodiments, the first portion 102a of the roof deck 102 is a first side of the roof deck and the second portion 102b of the roof deck 102 is a second side of the roof deck 102 opposite the first side. In some embodiments, the first side 107 of the ridge cap 106 is over the first side of the roof deck 102. In some embodiments, the second side 108 of the ridge cap 106 is over the second side of the roof deck 102.

In some embodiments, the array of the roofing modules 10 includes a first side and a second side opposite the first side. In some embodiments, a first wireway 74 is installed proximate to the first side of the array. In some embodiments, a second wireway 74 is installed proximate to the second side of the array. In some embodiments, a first wire cover 76 is installed on the first wireway 74. In some embodiments, a second wire cover 76 is installed on the second wireway 74. In some embodiments, a first joiner 110 attached to the first wire cover 76 overlays a first portion of the ridge cap 106. In some embodiments, a second joiner 110 attached to the second wire cover 76 overlays a second portion of the ridge cap 106. In some embodiments, the tab 118 of the first wire cover 76 and the tab 118 of the second wire cover 76 overlay the first side 107 of the ridge cap 106. In some embodiments, each of the first wire cover 76 and the second wire cover 76 is moveable in at least a first direction that extends along the first side 107 of the ridge cap, and each of the tabs 118 of the first wire cover 76 and the second cover 76 is configured to be positioned along the first side 107 of the ridge cap 106.

In some embodiments, the roofing system 100 includes a steep sloped roof. In some embodiments, the steeped sloped roof includes the roof deck 102 and the ridge 104. In some embodiments, the roof deck 102 includes a first portion 102a and a second portion 102b. In some embodiments, the first portion 102a is a first sloped side. In some embodiments, the second portion 102b is a second sloped side. In some embodiments, the ridge 104 is between the first portion 102a and the second portion 102b. In some embodiments, the ridge cap 106 is installed on the ridge 104. In some embodiments, the ridge cap 106 includes the first side 107 and the second side 108. In some embodiments, a first plurality of roofing modules 10 is installed on the first portion 102a of the roof deck 102. In some embodiments, the first plurality of roofing modules 10 is a plurality of photovoltaic modules. In some embodiments, the first plurality of roofing modules 10 is a plurality of non-photovoltaic modules. In some embodiments, the first plurality of roofing modules 10 is arranged in a first array. In some embodiments, the first array includes a first side and second side opposite the first side of the first array. In some embodiments, a second plurality of roofing modules 10 is installed on the second portion 102b of the roof deck 102. In some embodiments, the second plurality of roofing modules 10 is a plurality of photovoltaic modules. In some embodiments, the second plurality of roofing modules 10 is a plurality of non-photovoltaic modules. In some embodiments, the second plurality of roofing modules 10 is arranged in a second array. In some embodiments, the second array includes a first side and a second side opposite the first side of the second array. In some embodiments, a first wireway 74 is installed proximate to the first side of the first array. In some embodiments, a first wire cover 76 is installed on the first wireway 74. In some embodiments, a second wireway 74 is installed proximate to the second side of the first array. In some embodiments, a second wire cover 76 is installed on the second wireway 74. In some embodiments, a third wireway 74 is installed proximate to the first side of the second array. In some embodiments, a third wire cover 76 is installed on the third wireway 74. In some embodiments, a fourth wireway 74 is installed proximate to the second side of the second array. In some embodiments, a fourth wire cover 76 is installed on the fourth wireway 74. In some embodiments, the tab 118 of the first wire cover 76 overlays a first portion of the first side 107 of the ridge cap 106. In some embodiments, the tab 118 of the second wire cover 76 overlays a second portion of the first side 107 of the ridge cap 106. In some embodiments, the tab 118 of the third cover 76 overlays a first portion of the second side 108 of the ridge cap 106. In some embodiments, the tab 118 of the second wire cover 76 overlays a second portion of the second side 108 of the ridge cap 106.

In some embodiments, each of the first wire cover 76 and the second wire cover 76 is moveable in at least a first direction that extends along the first side 107 of the ridge cap 106. In some embodiments, each of the tabs 118 of the first wire cover 76 and the second wire cover 76 is configured to be positioned along the first side 107 of the ridge cap 106. In some embodiments, each of the third wire cover 76 and the fourth wire cover 76 is moveable in at least a second direction that extends along the second side 108 of the ridge cap 106. In some embodiments, each of the tabs 118 of the third wire cover 76 and the fourth wire cover 76 is configured to be positioned along the second side 108 of the ridge cap 106. In some embodiment, the first wire cover 76 and the second wire cover 76 when installed on the roof are symmetric with the third wire cover 76 and the fourth wire cover 76 when installed on the roof. In some embodiments, the first wire cover 76 and the second wire cover 76 when installed on the roof are asymmetric with the third wire cover 76 and the fourth wire cover 76 when installed on the roof. In some embodiments, the first, second, third and fourth wire covers 76 with the joiners 110 are configured to be positioned either symmetrically or asymmetrically along the ridge line of the ridge 104 to select a desired aesthetic appearance of the roofing system 100. In some embodiments, the wire covers 76 with the joiners 110 are configured to be positioned symmetrically along the ridge line of the ridge 104 to avoid rooftop obstructions that may not allow symmetric positioning of the wire covers 76 on either side of the ridge 104. In some embodiments, such obstructions may include vents, vent pipes, fans such as attic fans, skylights, chimneys, satellite dishes, and HVAC systems. In some embodiments, the joiners 110 are configured to provide aesthetic integration of the wire covers 76 with the ridge cap 106 and any ridge cap covers.

In some embodiments, the plurality of wireways 74 and associated wire covers 76 and joiners 110 may include two or more of the wireways 74 and associated wire covers 76 and joiners 110 on one or each of the first and second sides of the roof. In some embodiments, the plurality of wireways 74 and associated wire covers 76 and joiners 110 may include three or more of the wireways 74 and associated wire covers 76 and joiners 110 on one or each of the first and second sides of the roof. In some embodiments, the plurality of wireways 74 and associated wire covers 76 and joiners 110 may include four or more of the wireways 74 and associated wire covers 76 and joiners 110 on one or each of the first and second sides of the roof. In some embodiments, the plurality of wireways 74 and associated wire covers 76 and joiners 110 may include five or more of the wireways 74 and associated wire covers 76 and joiners 110 on one or each of the first and second sides of the roof. In some embodiments, the plurality of wireways 74 and associated wire covers 76 and joiners 110 may include six or more of the wireways 74 and associated wire covers 76 and joiners 110 on one or each of the first and second sides of the roof. In some embodiments, the plurality of wireways 74 and associated wire covers 76 and joiners 110 may include seven, eight, nine, ten, or more of the wireways 74 and associated wire covers 76 and joiners 110 on one or each of the first and second sides of the roof.

In some embodiments, the roof may have only the one ridge 104. In some embodiments, the roof may have a plurality of the ridges 104. In some embodiments, each of the ridges 104 are parallel to one another. In some embodiments, two of the ridges 104 are perpendicular to one another. In some embodiments, two or more of the ridges 104 may be perpendicular to two or more of other of the ridges 104.

The embodiments described herein are merely exemplary and that a person skilled in the art may make many variations and modifications without departing from the spirit and scope of the invention. All such variations and modifications are intended to be included within the scope of the invention.

What is claimed is:

1. A system, comprising:
a steep sloped roof,
wherein the roof includes a roof deck and a ridge;
a ridge cap installed on the ridge;
a plurality of photovoltaic modules installed on the roof deck,
wherein the plurality of photovoltaic modules is arranged in an array,
wherein the array includes a first side;
a wireway installed proximate to the first side of the array; and
a cover installed on the wireway,
wherein the cover includes an upper end, and
wherein the upper end overlays at least a portion of the ridge cap.

2. The system of claim 1, wherein the cover includes an elongated body and a tab extending from the body at the upper end, wherein the tab overlays the at least a portion of the ridge cap.

3. The system of claim 2, wherein the body includes a top section and side sections extending from the top section wherein the tab includes an upper portion, and wherein the upper portion of the tab extends from the top section of the body.

4. The system of claim 2, wherein the body includes a first portion and a second portion attached to the first portion, and wherein the second portion includes the tab.

5. The system of claim 4, wherein the second portion is removably attached to the first portion.

6. The system of claim 2, wherein the ridge cap includes a first side, and wherein the tab overlays the first side of the ridge cap.

7. The system of claim 6, wherein the first side of the ridge cap is sloped.

8. The system of claim 6, wherein the cover is moveable in at least a first direction that extends along the first side of the ridge cap, and wherein the tab is configured to be positioned along the first side of the ridge cap.

9. The system of claim 8, wherein the at least a first direction includes a first direction and a second direction opposite the first direction.

10. The system of claim 6, wherein the tab is attached to the first side of the ridge cap.

11. A system, comprising:
a steep sloped roof,
wherein the roof includes a roof deck and a ridge;
a ridge cap installed on the ridge;
a plurality of photovoltaic modules installed on the roof deck,
wherein the plurality of photovoltaic modules is arranged in an array,
wherein the array includes a first side and a second side opposite the first side;
a first wireway installed proximate to the first side of the array;
a second wireway installed proximate to the second side of the array;
a first cover installed on the first wireway; and
a second cover installed on the second wireway,
wherein each of the first cover and the second cover includes an upper end,
wherein the upper end of the first cover overlays a first portion of the ridge cap, and
wherein the upper end of the second cover overlays a second portion of the ridge cap.

12. The system of claim 11, wherein each of the first cover and the second cover includes an elongated body and a tab extending from the body at the upper end thereof, and wherein the tab of the first cover overlays the first portion of the ridge cap and the tab of the second cover overlays the second portion of the ridge cap.

13. The system of claim 12, wherein the body of each of the first cover and the second cover includes a first portion and a second portion attached to the first portion of the body, and wherein the second portion of the body includes the tab.

14. The system of claim 13, wherein the second portion of the body of each of the first cover and the second cover is removably attached to the first portion of the body.

15. The system of claim 12, wherein the ridge cap includes a first side, wherein the tab of the first cover and the tab of the second cover overlay the first side of the ridge cap.

16. The system of claim 15, wherein each of the first cover and the second cover is moveable in at least a first direction that extends along the first side of the ridge cap, and wherein each of the tabs of the first cover and the second cover is configured to be positioned along the first side of the ridge cap.

17. A system, comprising:
a steep sloped roof,
wherein the roof includes a roof deck and a ridge,
wherein the roof deck includes a first sloped side and a second sloped side, wherein the ridge is between the first sloped side and the second sloped side;
a ridge cap installed on the ridge,
wherein the ridge cap includes a first side and a second side;
a first plurality of photovoltaic modules installed on the first sloped side of the roof deck,
wherein the first plurality of photovoltaic modules is arranged in a first array,
wherein the first array includes a first side and second side opposite the first side of the first array;
a second plurality of photovoltaic modules installed on the second sloped side of the roof deck,
wherein the second plurality of photovoltaic modules is arranged in a second array,
wherein the second array includes a first side and a second side opposite the first side of the second array;
a first wireway installed proximate to the first side of the first array;
a first cover installed on the first wireway;
a second wireway installed proximate to the second side of the first array;
a second cover installed on the second wireway,
a third wireway installed proximate to the first side of the second array;
a third cover installed on the third wireway; and
a fourth wireway installed proximate to the second side of the second array; and
a fourth cover installed on the fourth wireway,
wherein each of the first cover, the second cover, the third cover and the fourth cover includes
an elongated body having an upper end, and
a tab extending from the body at the upper end,
wherein the tab of the first cover overlays a first portion of the first side of the ridge cap,
wherein the tab of the second cover overlays a second portion of the first side of the ridge cap,
wherein the tab of the third cover overlays a first portion of the second side of the ridge cap, and
wherein the tab of the second cover overlays a second portion of the second side of the ridge cap.

18. The system of claim 17, wherein each of the first cover and the second cover is moveable in at least a first direction that extends along the first side of the ridge cap, wherein each of the tabs of the first cover and the second cover is configured to be positioned along the first side of the ridge cap, wherein each of the third cover and the fourth cover is moveable in at least a second direction that extends along the second side of the ridge cap, and wherein each of the tabs of the third cover and the fourth cover is configured to be positioned along the second side of the ridge cap.

19. The system of claim 18, wherein the first cover and the second cover are symmetric with the third cover and the fourth cover.

20. The system of claim 18, wherein the first cover and the second cover are asymmetric with the third cover and the fourth cover.
